(19) United States
(12) Patent Application Publication
(10) Pub. No.: US 2014/0136111 A1
(43) Pub. Date: May 15, 2014

(54) OILFIELD PRODUCTION FORECASTING SYSTEM

(71) Applicant: SCHLUMBERGER TECHNOLOGY CORPORATION, Sugar Land, TX (US)

(72) Inventors: David John Rossi, Oxford (GB); Randy J. Vaal, Stafford, TX (US); Steve Reagan, Richmond, TX (US)

(73) Assignee: SCHLUMBERGER TECHNOLOGY CORPORATION, Sugar Land, TX (US)

(21) Appl. No.: 13/748,938

(22) Filed: Jan. 24, 2013

Related U.S. Application Data
(60) Provisional application No. 61/724,468, filed on Nov. 9, 2012.

(51) Int. Cl. E21B 49/00

(52) U.S. Cl. CPC E21B 49/003; G06F 17/60
USPC 702/6

(57) ABSTRACT

A system, method and computer readable medium capable of improving the efficiency and accuracy of oilfield production forecasting operations is described herein. Measured oilfield production data may be utilized to generate estimates for the mean, covariance and noise. Refined estimates for the mean and the covariance may be generated using a Bayesian probabilistic updating algorithm. The refined estimates may be utilized to generate an oilfield production forecast having a refined exponential decline curve associated with the measured production data and one or more uncertainty designations.

### RELATIONSHIP TO OTHER APPLICATION

This application claims the benefit of U.S. Provisional Application Ser. No. 61/724,468, filed Nov. 9, 2012, which is incorporated by reference herein in its entirety.

### BACKGROUND

Oilfield operations may involve multiple wells positioned at various locations of a reservoir. As hydrocarbons are extracted from a reservoir, new data is obtained and the operational plan(s) for managing the reservoir may need to be re-evaluated in order to maximize hydrocarbon production. Decisions may be made at each stage of the oilfield operation in order to properly allocate resources and assure that the reservoir meets its production potential.

Oilfield production forecasting involves the analysis of oilfield data in order to estimate future oilfield production. Production forecasts may be utilized to estimate the amount of fluid(s) recoverable from a hydrocarbon reservoir at different points in time. Production forecasting at each stage of the oilfield operation allows one to forecast future cash flow, design/augment production facilities, plan future well/field development and/or shut down unproductive wells.

Known oilfield production forecasting methods are computationally intensive and sensitive to both the amount of available data and the manner in which the available data is sampled and analyzed. As such, there remains a need for an oilfield production forecasting system capable of efficiently estimating future production and the uncertainty in future production, utilizing varying amounts of available data.

### SUMMARY

Accordingly, the present disclosure describes a system, method and computer readable medium capable of improving the efficiency, accuracy and uncertainty description of oilfield production forecasting. The present disclosure describes a more direct approach to oilfield production forecasting that utilizes measured oilfield production data to generate estimates describing the average behavior and the variability or uncertainty of exponential and other decline curves associated with each data point of the measured oilfield production data.

Measured oilfield production data relating to a well/reservoir of an oilfield operation may be received and stored. In one embodiment, an exponential decline curve associated with the measured production data may be identified and expressed as a two dimensional vector having an amplitude parameter A and a rate of exponential decline parameter τ. Other types of declines curves such as hyperbolic or harmonic, each represented in terms of several parameters, may be similarly considered.

In one embodiment, parameters A and τ of the exponential decline curve associated with the measured production data may be estimated and utilized to generate a graphical representation of the exponential decline curve associated with the measured oilfield production data in the past and the future. Because future production is unknown, the two parameters A and τ may be considered to be uncertain parameters. These two parameters may be expressed as a two-dimensional vector, and the mean and covariance of the two dimensional vector may be estimated using the measured oilfield production data. In one embodiment, fluctuations in the measured oilfield production data away from the associated exponential decline curve may be considered to be measurement “noise” at each time step of the measured production data.

In one embodiment, as new production data is measured/received, the mean and covariance of the two-dimensional vector may be updated and/or refined using a Bayesian probabilistic updating algorithm. In one embodiment, the Bayesian probabilistic updating algorithm may utilize the estimated mean, the estimated covariance, and the estimated properties of the measurement noise in order to arrive at a refined mean and a refined covariance for the two-dimensional vector.

The refined estimates for the mean and covariance of the two-dimensional vector may be utilized to generate a refined exponential decline curve associated with the measured production data. In one embodiment, the uncertainty associated with the refined exponential decline curve may be estimated and displayed along with the refined exponential decline curve in order to denote the uncertainty in the production forecast for the oilfield or reservoir at issue. The methods described herein may be iteratively repeated as new oilfield production data becomes available, providing the user with the most up-to-date forecasting information based on all of the available measurement data.

This summary is provided to introduce a selection of concepts in a simplified form that are further described herein. This summary is not intended to identify key or essential features of the claimed subject matter, nor is it intended to be used as an aid in determining the scope of the claimed subject matter. This summary is illustrated with the example of an exponential decline curve, but other parametric decline curves may similarly be considered.

### BRIEF DESCRIPTION OF THE DRAWINGS

A more complete appreciation of the present disclosure and many of the attendant advantages thereof will be readily obtained as the same becomes better understood by reference to the following detailed description when considered in connection with the accompanying drawings; it being understood that the drawings contained herein are not necessarily drawn to scale and that the accompanying drawings provide illustrative implementations and are not meant to limit the scope of various technologies described herein; wherein:

FIG. 1 is a graphical representation of measured oilfield production data in one example embodiment.

FIG. 1A is a flow chart diagram illustrating an oilfield production forecasting process of one example embodiment.

FIG. 2 is a graphical representation of a semi-log plot of measured oilfield production data in one example embodiment.

FIG. 3 is a graphical representation of measured oilfield production data and an associated exponential decline curve of one example embodiment.

FIG. 4 is a graphical representation of measured oilfield production data and a refined exponential decline curve of one example embodiment.

FIG. 5 is a graphical representation of measured oilfield production data, a refined exponential decline curve and uncertainty indicators of one example embodiment.

FIG. 6 is a schematic illustration of a computer system of one example embodiment.

### DETAILED DESCRIPTION

In the following description, numerous details are set forth to provide an understanding of various embodiments of the invention. However, it will be understood by those skilled in the art that the invention may be practiced without these details and that numerous variations or modifications from the described embodiments may be possible.

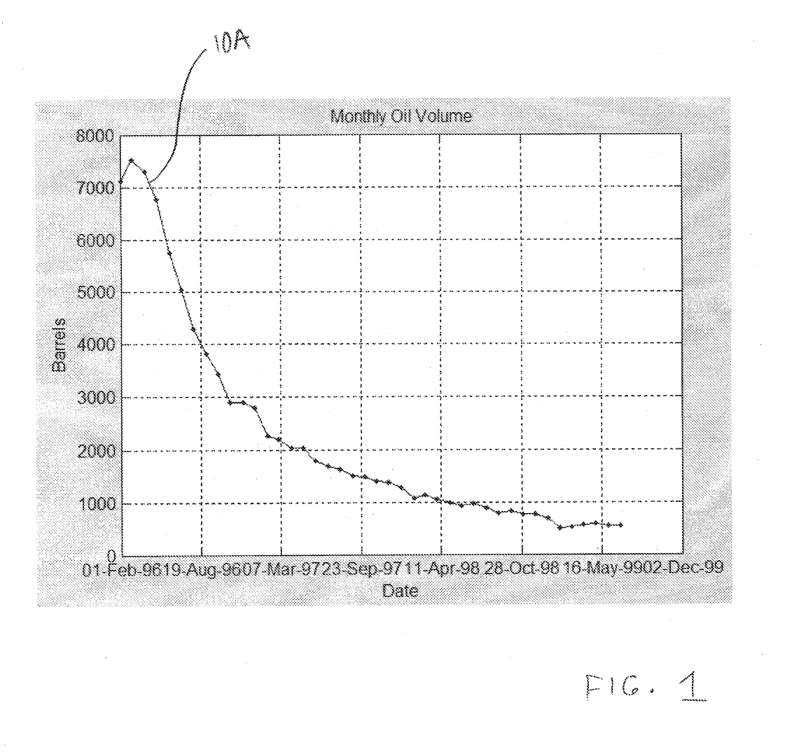

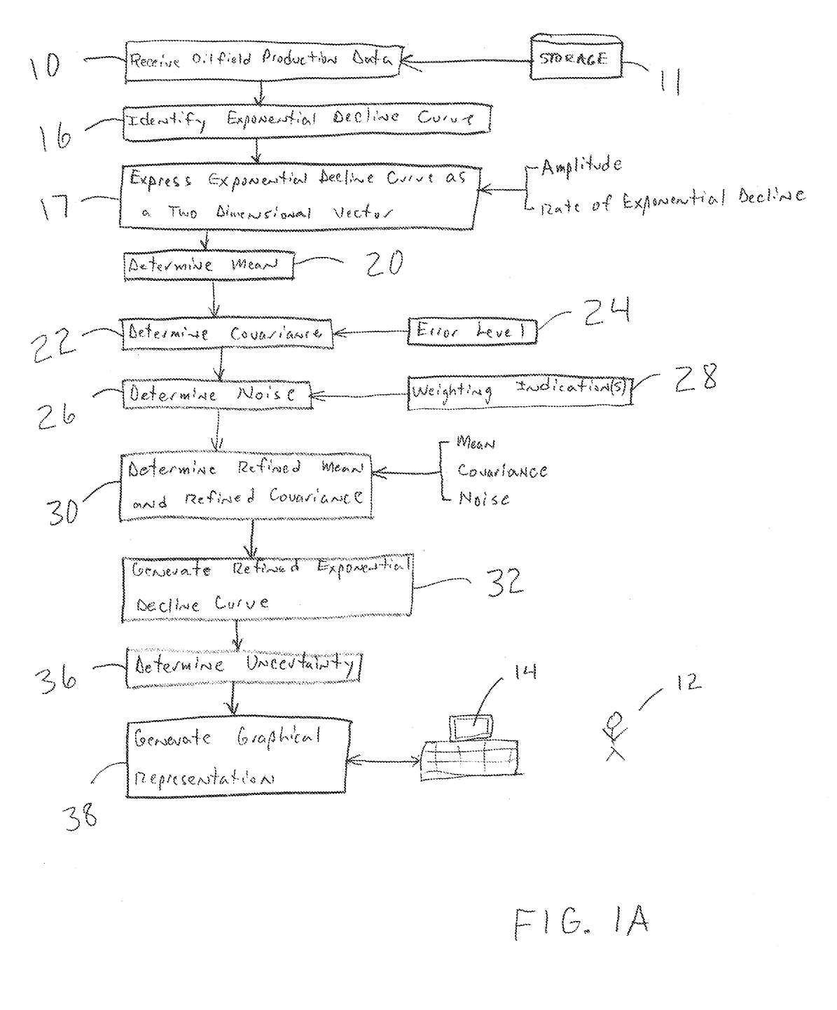

The present disclosure describes embodiments of a method of forecasting oilfield production, a computer readable medium for forecasting oilfield production and a computer system for forecasting oilfield production. FIG. 1 illustrates an example set of oilfield production data for an oilfield operation expressed in terms of monthly oil production volume versus time.

Oilfield production data may be collected/measured using sensors positioned about the oilfield. For example, sensors in the wellbore may monitor/measure fluid composition, sensors located along the surface flow path may monitor/measure production flow rates, and sensors at the processing facility may monitor/measure fluids collected. The oilfield production data shown in FIG. 1 illustrates an example situation where the monthly well oil production volume of a well/reservoir declines from over 7000 barrels per month in February 1996 to around 500 barrels per month in May of 1999.

Measured oilfield production data (10A) relating to a well/reservoir of an oilfield operation may be received and stored, as illustrated by Box (10) of FIG. 1A. Such data may be received directly from oilfield sensing equipment or via a storage device (11) containing production data. In one embodiment, a graphical representation of the measured production data may be generated and displayed to the user (12) via a graphical user interface (14). The graphical representation may or may not be similar to the example graphical representation of FIG. 1.

In one embodiment, an exponential decline curve associated with the measured production data may be identified, as illustrated by Box (16) of FIG. 1A. In one embodiment, this involves expressing the measured production data, obtained at N measurement times, as an N-dimensional vector as illustrated by equation 1 (below).

d(t),t=t₁,t₂, . . . ,t_{N} (Eq 1)

Although the use of an exponential decline curve is described in relation to many of the examples provided herein, it should be understood that other parametric decline curves, such as hyperbolic, harmonic and others, may be utilized instead of or in combination with the exponential decline curve. In one embodiment, the parameters for each type of decline curve may be provided and assumed to be random variables in accordance with the principles described herein.

The exponential decline curve may be expressed in the form of equation 2 (below) such that the exponential decline may be described by two free parameters: (1) an amplitude parameter A and (2) a rate of exponential decline parameter τ. These two parameters may be expressed as a 2-dimensional vector u in the form of equation 3 (below), as illustrated by Box (17) of FIG. 1A.

$$\begin{matrix}q ( t ) = A {e}^{- t / τ} & ( Eq 2 ) \\ u = [ \begin{matrix}A \\ τ\end{matrix} ] & ( Eq 3 )\end{matrix}$$

Parameters A and τ of the exponential decline curve associated with the measured production data may be initially estimated by taking the logarithm of both sides of equation 2 in order to generate equation 4 as follows:

y(t)=ln q(t)=ln A−t/r (Eq 4)

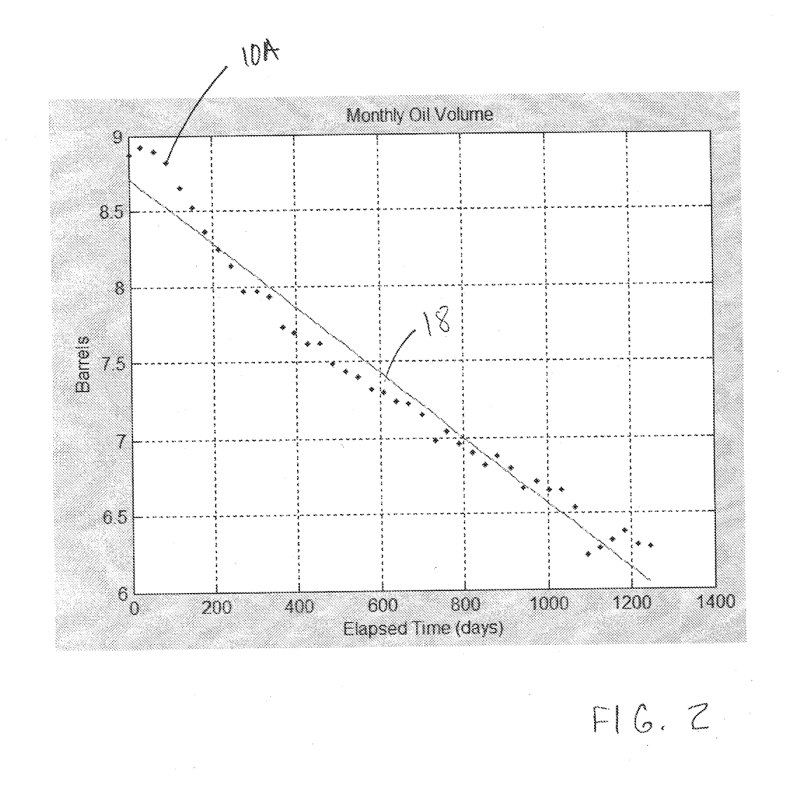

In this example, equation 4 is a linear equation having independent time variable t, a slope of −(1/r) and an intercept of ln A. A semi-log plot of the measured production data may be generated, as illustrated by FIG. 2, and a straight line (18) that best fits the measured production data in the semi log plot may be determined. In one embodiment, a least squares linear regression approach may be utilized to determine the best fitting straight line (18) for the semi-log plot of the measured oilfield production data (10A).

The slope and intercept of the best fitting straight line (18) may be utilized to provide an initial estimate for parameters A and τ of the 2-dimensional vector u, providing the following average or mean values for A and τ in this example:

A=6070 barrels/month; τ=467 days (Eq 5)

The estimated values for A and τ of two-dimensional vector u may then be utilized to generate the exponential decline curve associated with the example measured production data of FIG. 1. In one embodiment, this may be accomplished by inserting estimated A and τ values into exponential equation 2 (above) over the time interval of the measured production data.

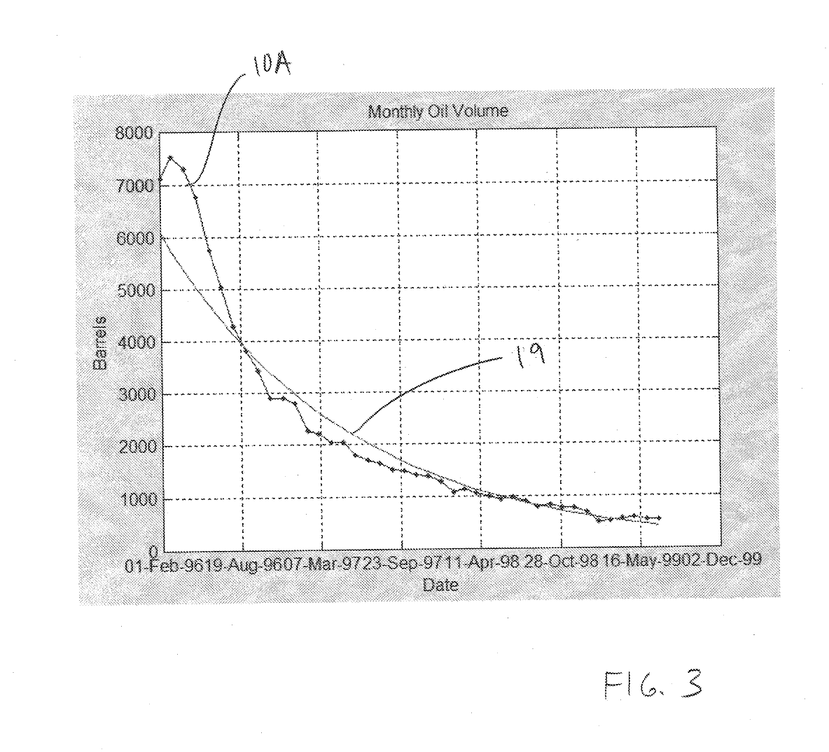

A graphical representation illustrating the associated exponential decline curve and the measured production data may be generated and displayed to the user (12) via a graphical user interface (14). FIG. 3 illustrates an example graphical representation of the exponential decline curve (19) associated with the measured production data (10A) in this example.

In one embodiment, in order to represent the uncertainty about the exponential decline curve (19) associated with the measured production data, it may be represented as a random decline curve. In one embodiment, parameters A and τ of the 2-dimensional vector u, may be expressed as random or imprecisely known quantities such that u may be considered to be a 2-dimensional random variable having a first moment (mean) and a second moment (covariance). In this example, the mean of two dimensional vector u may be expressed by the variable mᵤ and the covariance may be expressed by the variable Lᵤᵤ.

The mean mᵤ of two dimensional vector u may be initially estimated as the parameters A and τ of the straight line best fitting the semilog production data (as described above) and expressing them as shown in equation 6a, as illustrated by Box (20) of FIG. 1A.

$${m}_{u} = [ \begin{matrix}A \\ τ\end{matrix} ] \qquad ( Eq 6 a )$$

Based on the initial computation from the measured oilfield production data, the covariance Lᵤᵤ of the two dimensional vector u may be expressed as a 2×2 matrix as shown in equation 6b (below) and solved, as illustrated by Box (22) of FIG. 1A.

$${L}_{uu} = [ \begin{matrix}{σ}_{A}^{2} & 0 \\ 0 & {σ}_{τ}^{2}\end{matrix} ] \qquad ( Eq 6 b )$$

In one embodiment, parameters A and τ may be assumed to be uncorrelated, which means that the off-diagonal terms of the 2×2 matrix of equation 6b may be assumed to be zero. In one embodiment, this assumption may be utilized to assume that knowledge about the value of A being smaller or larger than the mean value provides no information, a priori, about the deviations of τ away from its mean value, and vice versa. If this assumption is not made, the off-diagonal terms of the 2×2 matrix of equation 6b may be specified with nonzero values.

The standard deviation values, situated on the diagonal of the matrix in Equation 6b, may be estimated in several ways. To simplify the approach, it may be assumed that the standard deviation values represent a percentage error with respect to the mean value, as illustrated by Box (24) of FIG. 1A. In the example above, a ±50% error level is assumed so that equation 6b becomes:

$${L}_{uu} = [ \begin{matrix}{( 0.5 \times A )}^{2} & 0 \\ 0 & {( 0.5 \times τ )}^{2}\end{matrix} ] = [ \begin{matrix}9.2 \times {10}^{5} & 0 \\ 0 & 5.5 \times {10}^{4}\end{matrix} ] \qquad ( Eq 6 c )$$

In one embodiment, the system may provide a graphic user interface through which the user may manually enter or import error level information to be utilized in conjunction with equation 6c. Solving for Lᵤᵤ in equation 6c generates an estimated standard deviation (square root of the diagonal terms of the covariance) of the two dimensional vector u of ±3035 barrels/month for the amplitude parameter A and an estimated standard deviation of ±234 days for the exponential rate of decline parameter τ as shown in equation 6d.

A=6070±3035 barrels/month; τ=467±234 days (Eq 6d)

In one embodiment, fluctuation of the measured production data (10A) away from the associated exponential decline curve (19) may be considered to be random measurement “noise” and the amount of measurement noise may be calculated for each time step of the measured production data, as illustrated by Box (26) of FIG. 1A. Specifically, the measured production data d(t) in equation 1 may be mathematically considered to be noisy or uncertain measurements of the associated exponential decline curve q(t) in equation 2.

As such, the N-dimensional measured production data may be written as shown in equation 7 (below) where v(t) is considered to be random measurement “noise” and is expressed as the difference between the measured production data d(t) and the exponential decline curve q(t) associated with the measured production data.

d(t)=q(t) v(t) (Eq 7)

In one embodiment, the random measurement noise v(t) may be expressed as an N-dimensional random variable characterized by its first moment (mean value) and second moment (covariance matrix). In one embodiment, the random measurement noise may be assumed to have a zero mean value, and a second moment may be represented by an N×N covariance matrix Lᵥᵥ, given by equation 8 as follows:

$${L}_{vv} = [ \begin{matrix}{σ}_{{v }_{1}}^{2} & & 0 \\ & ⋱ & \\ 0 & & {σ}_{{v}_{N}}^{2}\end{matrix} ] = [ \begin{matrix}{w}_{1} {v}_{1}^{2} & & 0 \\ & ⋱ & \\ 0 & & {w}_{N} {v}_{N}^{2}\end{matrix} ] \qquad ( Eq 8 )$$

In this example, v₁ in equation 8 may represent the noise (that is, the fluctuation between the measured production and the decline curve) at the first time step while v_{N} may represent the noise at time step N. As one of ordinary skill in the art would recognize, the number of time steps will depend on the number of available data points for the measured production data.

In one embodiment, it may be assumed that there is no correlation in the measurement noise between individual data point time steps of the measured oilfield production data. That is, knowledge that the measured production is above or below the decline curve at one time step is assumed to provide no information about whether the measured production is above or below the decline curve at another time step. This assumption simplifies the noise Lᵥᵥ computation in that the off-diagonal terms of the matrices of equation 8 may be assumed to be zero.

This “uncorrelated” option may be provided to the user via a check box or other suitable interface where the user can indicate that he or she wishes to assume that there is no correlation between some or all of the measured oilfield production data points. For example, for data points where the user indicates an uncorrelated relationship, the system may automatically populate the corresponding diagonals with zeros.

In one embodiment, the system may provide a graphic user interface where the user may manually enter or import numerical correlation information into one or more of the diagonals of the matrices of equation 8. In one embodiment, numerical correlation information may include non-zero positive numbers and the user may be given the option to incorporate such numbers into some or all of the diagonals of the matrices.

In one embodiment, w₁, . . . w_{N} in equation 8 may represent weighting indications that may be applied at each time step of the noise calculation, as illustrated by Box (28) of FIG. 1A. In one embodiment, weighting indications may include numerical indicators pertaining to the confidence to be placed in one or more data points of the measured oilfield production data. This feature allows the user to affect the “fit” of the exponential decline curve to the measured oilfield production data on a per-data-point basis.

For example, suppose the user has greater confidence in the measured oilfield production data for the final oilfield production data point due to an upgrade to a more accurate production measuring device at the oilfield. In one embodiment, the system allows the user to indicate greater confidence in the last data point by entering a zero or a small positive number close to zero for the last data point. In this example, an entry of zero or a small number close to zero would indicate a smaller amount of measurement noise and a tighter fit of the exponential decline curve to the measured oilfield production data at that point. Likewise, for data points where the user has less confidence in the data measurements, he or she may enter a larger positive number to indicate a larger amount of measurement noise, resulting in a looser fit of the exponential decline curve to the measured production data at those points.

This feature of the invention allows the user to tailor the exponential decline curve according to personal preference and/or knowledge concerning the oilfield operation at issue. For example, the user may prefer to see a decline curve that provides a tighter fit at more recent data points, i.e., at later stages of the oilfield operation. In one embodiment, the user may do this by entering zero or small positive weighting indications for data points near the end of the curve and larger numbers at earlier data points.

In one embodiment, a graphical user interface may be provided to receive user entered weighting indications. Such indications may be manually entered by the user or imported from previously stored weighting indication arrangements. In one embodiment, the system may provide access to a database of stored weighting indications for various types of measuring equipment such that the user need only select the measuring device used for one or more data points and the system automatically retrieves default weighting indication(s) and inserts them into the appropriate matrix diagonal for the data points indicated by the user.

In one embodiment, the estimated mean mᵤ and the estimated covariance Lᵤᵤ of two dimensional vector u, which characterize the degree of undertainty in the decline curve parameters A and τ, in this example, may be understood to change with time as additional measurements of the declining production become available. As time advances, the new production measurement information may be used to refine the estimates of parameters A and τ in order to improve production forecasting results, as illustrated by Box (30) of FIG. 1A. In one embodiment, a Bayesian probabilistic updating arrangement may be utilized in order to generate a refined mean n_{u|d} and a refined covariance L_{uu|d} for the two-dimensional vector u. The Bayesian probabilistic updating arrangement may be implemented using a Bayesian probabilistic updating algorithm.

In one embodiment, the Bayesian probabilistic updating algorithm may utilize the latest estimate of the mean mᵤ, the latest estimate of the covariance Lᵤᵤ of two dimensional vector u and the latest estimate of the N×N measurement noise covariance Lᵥᵥ in order to arrive at a refined mean m_{u|d} and a refined covariance L_{uu|d} for the two dimensional vector u, given the latest measurement data in the N-dimensional vector d. To begin, the measurement data in the vector d may be compared to the N-dimensional decline curve q at the sample times computed using the parameters in the mean mᵤ(t), and the N-dimensional vector of differences v=d−q (sometimes referred to as residuals) using equation 7 may be computed. In one embodiment, the refined mean m_{u|d} and the refined covariance L_{uu/|d} of the two-dimensional vector u given the data in the measurement vector d may be expressed using a Bayesian probabalistic updating algorithm as shown in equations 9 and 10 (below), respectively, where v=d−q is the N-dimensional vector of residuals:

m_{u|d}=mᵤ+(∇_{q}Lᵤᵤ)′K⁻¹v (Eq 9)

L_{uu|d}=Lᵤᵤ−(∇_{q}Lᵤᵤ)′K⁻¹(∇_{q}Lᵤᵤ) (Eq 10)

In one embodiment, the Bayesian Probabalistic updating algorithm, K in this example, may be utilized to denote the N×N covariance update, or “gain matrix” in this example, which may then be expressed as shown in equation 11 (below) where V_{q} may be an N×2 matrix of derivative information (illustrated below in equation 12a using g₁ and g₂ designations) about the exponential function q(t) in equation 2. Specifically, in one embodiment, ∇_{q} may represent an N×2 matrix where the first column represents the derivative of q(t) with respect to the A parameter (denoted as g₁ in equation 12b below) and the second column represents the derivative of q(t) with respect to the τ parameter (denoted as g₂ in equation 12c below); while ∇_{q}′ may be utilized to represent the 2×N transpose of the N×2 matrix ∇_{q}.

$$\begin{matrix}K = ( {∇}_{q} {L}_{uu} {∇}_{q}^{t} ) + {L}_{vv} & ( Eq 11 ) \\ {∇}_{q} = [ {g}_{1} {g}_{2} ] & ( Eq 12 a ) \\ {g}_{1} = \frac{d q}{d A} = {e}^{- t / τ} & ( Eq 12 b ) \\ {g}_{2} = \frac{d q}{d τ} = \frac{A t}{{τ}^{2}} {e}^{- t / τ} & ( Eq 12 c )\end{matrix}$$

Solving for the refined mean for the decline curve parameters, m_{u|d} in equation 9 generates a refined estimate for the mean of the 2-dimensional vector u of 6411 barrels/month for amplitude parameter A and a refined estimate for the mean of 472 days for the exponential rate of decline parameter τ, as illustrated in equation 12d (below). The subscript “2” is utilized to refer to the fact that the Bayesian probablistic algorithm has moved to another iteration, to generate refined estimates of A and τ in this example.

A₂=6411±1712 barrels/month; τ₂=472±88 days (Eq 12d)

Further, solving for the refined covariance of the two decline curve parameters L_{uu|d} in equation 10 (above) generates a refined estimate for the covariance of the 2-dimensional vector u, with the square root of the diagonal elements corresponding to an estimated standard deviation (square root of the variance) of ±1712 barrels/month for the amplitude parameter A and an estimated standard deviation of ±88 days for the exponential rate of decline parameter τ in this example. Comparision of the refined mean m_{u|d} and covariance L_{uu|d} estimates in equation 12d to the initial values of the mean mᵤ and covariance Lᵤᵤ estimates in equation 6d illustrates a noticeable reduction in the standard deviations of these production forecasting parameters.

The refined estimates for the mean m_{u|d} and covariance L_{uu|d} of the 2-dimensional vector u may be utilized to generate a refined exponential decline curve associated with the measured production data, as illustrated by Box (32) of FIG. 1A. In one embodiment, this may be accomplished by inserting the refined estimated random parameters A and τ values into decline curve parametric equation 13 (below).

m_{q}(t)=m_{A}e^{-t/m}^{_{T}}=6411e^{-t/472} (Eq 13)

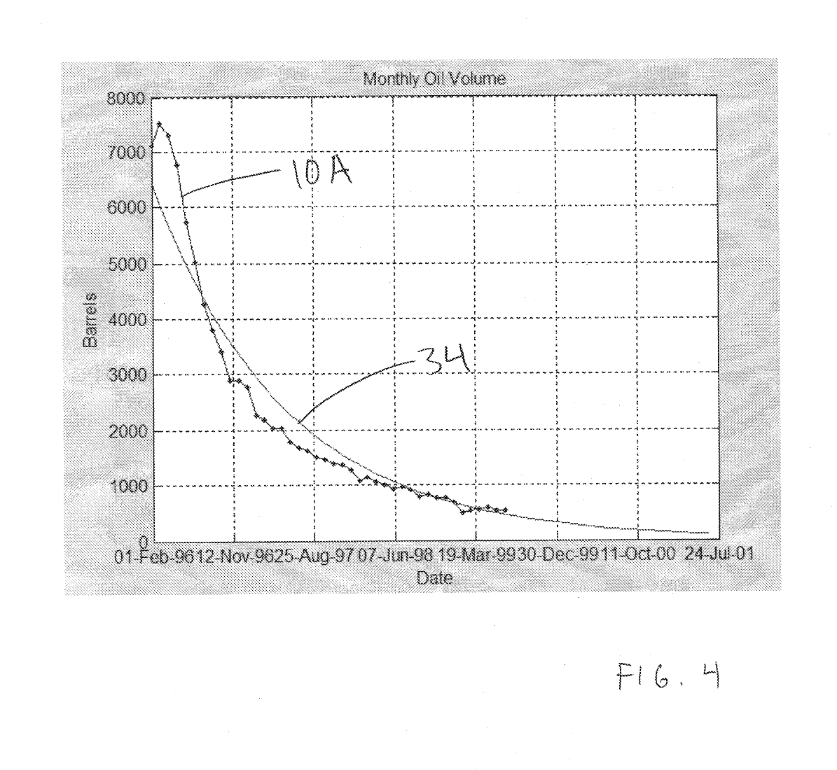

A graphical representation illustrating the refined exponential decline curve and the measured production data may be generated and displayed to the user (12) via a graphical user interface (14). FIG. 4 illustrates an example graphical representation of the refined exponential decline curve (34) and the measured production data (10A) in this example.

FIG. 4 shows a single decline curve corresponding to the mean values of the refined estimates of A and τ after the Bayesian updating algorithm has been applied in this example. However, the decline curve parameters A and τ are considered to be random variables in this example, characterized by their first moment (mean) and second moment (covariance). The corresponding random decline curve may be characterized by its mean value (shown in FIG. 4) and its covariance, which may relate to the expected variation or fluctuation away from the mean value. In one embodiment, it may be desirable to represent the covariance of the decline curve, and to relate that to the uncertainty in expected future production as estimated using the decline curve forecasting. Said another way, it may be desirable to relate the uncertainty in the two decline curve random parameters A and τ to the uncertainty in the exponential decline curve (34) generated by the refined estimates for two dimensional vector u, as illustrated by Box (36) of FIG. 1A. In one embodiment, the uncertainty of the A₂ and τ₂ parameters of the 2-dimensional vector u may be related to the value of monthly production volume.

In one embodiment, this may be accomplished by generating an expression of an oil volume decline curve vector q₂(t) that is related to the A₂ and τ₂ parameters of the two dimensional vector u as shown in equation 14 (below).

q₂(t)=A₂e^{-t/T}^{₂} (Eq 14)

The oil volume decline curve vector q₂(t) may then be expressed as a Taylor series expansion around m_{q}(t) as shown in equation 15 (below).

q₂(t)=m_{q}(t)+∇_{q}δᵤ+higher order terms (Eq 15)

The oil volume decline curve q₂(t) may be expressed as its mean value m_{q}(t) plus a deviation of q₂(t) away from m_{q}(t) denoted as δ_{q2}. It should be understood that higher order terms of the Taylor expansion series may be small compared to the first order term m_{q}(t) and second order term ∇_{q}δᵤ, and thus the higher order terms may be ignored in this example for ease of explanation. Equation 16 may include some or all of the higher order Taylor expansion series terms as needed to provide a sufficiently accurate uncertainty calculation. In one embodiment, only the two lowest order terms of the Taylor series expansion are maintained, in conjunction with equation 16, due to the small size of other higher order terms, i.e., third order terms, fourth order terms, etc., and to promote computational efficiency.

Equation 16 relates variations in the 2-dimensional vector u parameters A₂ and τ₂ to variations in the oil volume decline curve vector q₂(t). In one embodiment, q₂(t) may be assumed to comprise an N-dimensional vector of historical (past) measured production data and an M-dimensional vector of future measured production data.

δ_{q2}=q₂(t)−m_{q}(t)=∇_{q}δᵤ (Eq 16)

In one embodiment, the covariance or uncertainty of the refined exponential decline curve (34) may be expressed as the expected value (overbar notation denotes expected value in this example) shown in equation 17 (below).

$$\begin{matrix}cov ( {δ}_{q 2} ) = \overline{{δ}_{q 2} {δ}_{q 2}^{′}} \\ = \overline{{∇}_{q} {δ}_{u} {δ}_{u}^{′} {∇}_{q}^{′}} \\ = {∇}_{q} \overline{{δ}_{u} {δ}_{u}^{′}} {∇}_{q}^{′} \\ = {∇}_{q} {L}_{uu \vert d} {∇}_{q}\end{matrix} \qquad ( Eq 17 )$$

Equation 17 provides an (N+M)×(N+M) covariance matrix, the diagonal entries of which provide the magnitude of the uncertainty in the refined exponential decline curve (34) at every sample time, including past and future sample times. A graphical representation illustrating the uncertainty of the refined exponential decline curve (34) may be generated and displayed to the user (12) via a graphical user interface (14), as illustrated by Box (38) of FIG. 1A.

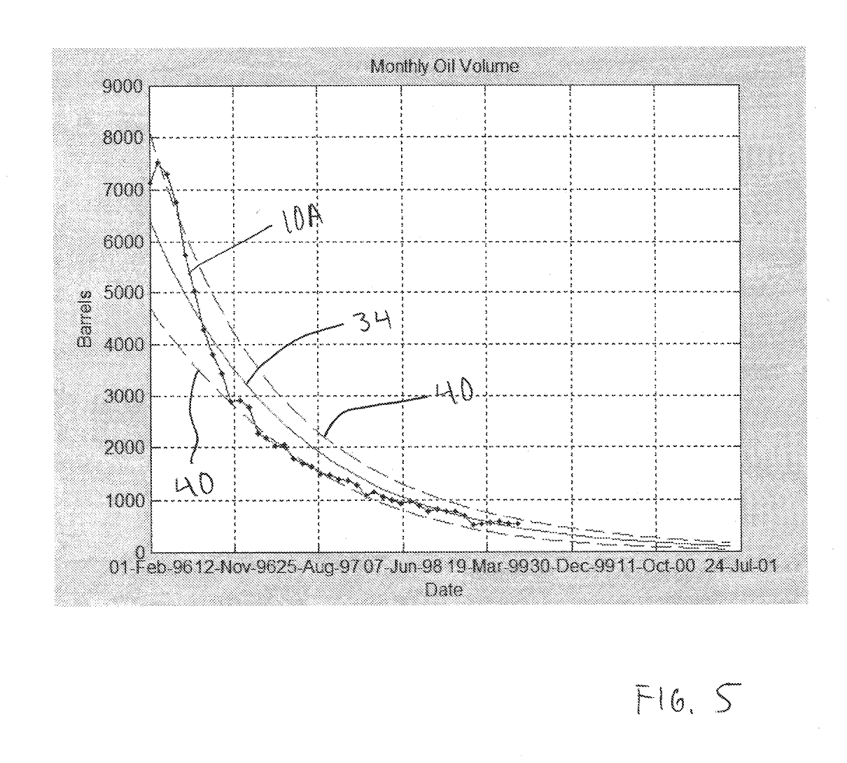

An example graphical representation of the refined exponential decline curve (34) shown in conjunction with the degree of uncertainty in the decline curve expressed in equation 17 is provided in FIG. 5. In one embodiment, dashed curves (40) on either side of the exponential decline curve (34), covering both past and future intervals of time, may be utilized to graphically illustrate the uncertainty of the refined exponential decline curve (34) obtained from the covariance calculation in equation 17.

The method, system and computer readable medium described herein is capable of generating an oilfield production forecast including a parametric decline curve and associated uncertainties at any point in time. Consider, for example, the measured production data shown in FIGS. 1, 3-5 having a final data point with a monthly oil volume of about 531 barrels dated Jul. 1, 1999. Suppose that a production analyst is tasked with generating a production forecast for an oilfield at a point in time two years into the future (which would be Jul. 1, 2001 in this example).

The monthly production volume two years into the future may be determined, as described above, by evaluating the mathematical expression for the refined exponential decline curve (34) two years into the future, along with the uncertainty as described above in relation to equation 17 and illustrated by the dashed curves in FIG. 5. Doing so provides an estimated monthly production volume of about 98.9 barrels per month and an uncertainty of about 61.4 barrels per month as of Jul. 1, 2001. In one embodiment, the above procedures may be repeated and/or updated each time new oilfield production data is acquired using the Bayesian probabalistic updating algorithm illustrated in equations 9 through 12, providing the user with up-to-date forecasts based on the latest data.

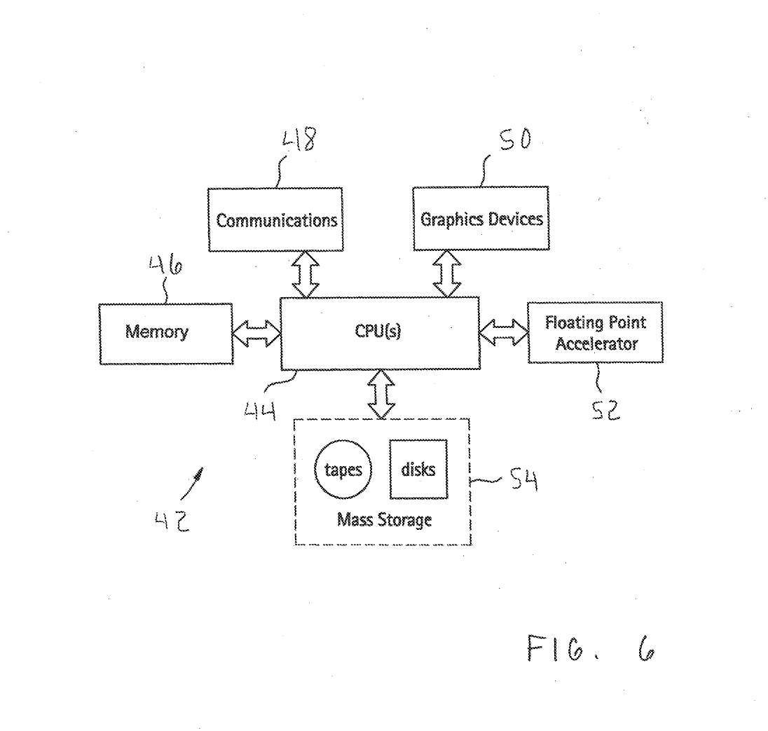

The methods described herein may be implemented on any suitable computer system capable of processing electronic data. FIG. 6 illustrates one possible configuration of a computer system (42) that may be utilized. Computer system(s), such as the example system of FIG. 6, may run programs containing instructions, that, when executed, perform methods according to the principles described herein. Furthermore, the methods described herein may be fully automated and able to operate continuously, as desired.

The computer system may utilize one or more central processing units (44), memory (46), communications or I/O modules (48), graphics devices (50), a floating point accelerator (52), and mass storage devices such as tapes and discs (54). Storage device (54) may include a floppy drive, hard drive, CD-ROM, optical drive, or any other form of storage device. In addition, the storage devices may be capable of receiving a floppy disk, CD-ROM, DVD-ROM, disk, flash drive or any other form of computer-readable medium that may contain computer-executable instructions. Further communication device (48) may be a modem, network card, or any other device to enable communication to receive and/or transmit data. It should be understood that the computer system (42) may include a plurality of interconnected (whether by intranet or Internet) computer systems, including without limitation, personal computers, mainframes, PDAs, cell phones and the like.

It should be understood that the various technologies described herein may be implemented in connection with hardware, software or a combination of both. Thus, various technologies, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computer, the machine becomes an apparatus for practicing the various technologies.

In the case of program code execution on programmable computers, the computing device may include a processor, a storage medium readable by the processor (including volatile and non-volatile memory and/or storage elements), at least one input device, and at least one output device. One or more programs that may implement or utilize the various technologies described herein may use an application programming interface (API), reusable controls, and the like. Such programs may be implemented in a high level procedural or object oriented programming language to communicate with a computer system. However, the program(s) may be implemented in assembly or machine language, if desired. In any case, the language may be a compiled or interpreted language, and combined with hardware implementations.

The computer system (42) may include hardware capable of executing machine readable instructions, as well as the software for executing acts that produce a desired result. In addition, computer system (42) may include hybrids of hardware and software, as well as computer sub-systems.

Hardware may include at least processor-capable platforms, such as client-machines (also known as personal computers or servers), and hand-held processing devices (such as smart phones, personal digital assistants (PDAs), or personal computing devices (PCDs), for example). Further, hardware may include any physical device that is capable of storing machine-readable instructions, such as memory or other data storage devices. Other forms of hardware include hardware sub-systems, including transfer devices such as modems, modem cards, ports, and port cards, for example.

Software includes any machine code stored in any memory medium, such as RAM or ROM, and machine code stored on other devices (such as floppy disks, flash memory, or a CD ROM, for example). Software may include source or object code, for example. In addition, software encompasses any set of instructions capable of being executed in a client machine or server.

A database may be any standard or proprietary database software, such as Oracle, Microsoft Access, SyBase, or DBase II, for example. The database may have fields, records, data, and other database elements that may be associated through database specific software. Additionally, data may be mapped. Mapping is the process of associating one data entry with another data entry. For example, the data contained in the location of a character file can be mapped to a field in a second table. The physical location of the database is not limiting, and the database may be distributed. For example, the database may exist remotely from the server, and run on a separate platform.

Further, the computer system may operate in a networked environment using logical connections to one or more remote computers. The logical connections may be any connection that is commonplace in offices, enterprise-wide computer networks, intranets, and the Internet, such as local area network (LAN) and a wide area network (WAN). The remote computers may each include one or more application programs.

When using a LAN networking environment, the computer system may be connected to the local network through a network interface or adapter. When used in a WAN networking environment, the computer system may include a modem, wireless router or other means for establishing communication over a wide area network, such as the Internet. The modem, which may be internal or external, may be connected to the system bus via the serial port interface. In a networked environment, program modules depicted relative to the computer system, or portions thereof, may be stored in a remote memory storage device.

Although the invention has been described with reference to specific embodiments, this description is not meant to be construed in a limited sense. Various modifications of the disclosed embodiments, as well as alternative embodiments of the invention, will become apparent to persons skilled in the art upon reference to the description of the invention. It is, therefore, contemplated that the appended claims will cover such modifications that fall within the scope of the invention.

What is claimed is:

1. A computer implemented method of forecasting oilfield production comprising:
a computer processor operative to:
receive measured oilfield production data;
identify an exponential decline curve associated with the measured oilfield production data;
express the associated exponential decline curve as a two dimensional vector;
determine a mean and a covariance for the two dimensional vector;
determine a refined mean and a refined covariance for the two dimensional vector; and
generate a refined exponential decline curve utilizing the refined mean and the refined covariance.

2. The computer implemented method of claim 1, further comprising:
generating a graphical representation of the refined exponential decline curve.

3. The computer implemented method of claim 1, further comprising:
determining a noise attributable to the associated exponential decline curve.

4. The computer implemented method of claim 3, wherein the refined mean and the refined covariance are determined utilizing a Bayesian probabilistic updating algorithm which utilizes the mean, the covariance, and the noise.

5. The computer implemented method of claim 3, wherein the noise further comprises a weighting indication pertaining to at least a portion of the measured production data.

6. The computer implemented method of claim 1, further comprising:
determining an uncertainty associated with the refined exponential decline curve; and
generating a graphical representation of the uncertainty.

7. The computer implemented method of claim 1, wherein the two dimensional vector has an amplitude parameter and a rate of exponential decline parameter.

8. The computer implemented method of claim 1, wherein the amplitude parameter and the rate of exponential decline parameter are uncorrelated.

9. The computer implemented method of claim 1, further comprising:
determining the amplitude parameter and the rate of exponential decline parameter for the two dimensional vector.

10. The computer implemented method of claim 9, further comprising:
determining a refined amplitude parameter and a refined rate of exponential decline utilizing the refined mean and the refined covariance.

11. A computer system for forecasting oilfield production comprising:
a computer processor operative to:
receive measured oilfield production data;
identify an exponential decline curve associated with the measured oilfield production data;
express the associated exponential decline curve as a two dimensional vector having an amplitude parameter and a rate of exponential decline parameter, wherein the amplitude parameter and the rate of exponential decline parameter are uncorrelated;
determine a mean and a covariance for the two dimensional vector;
determine a refined mean and a refined covariance for the two dimensional vector;
generate a refined exponential decline curve utilizing the refined mean and the refined covariance;
determine an uncertainty associated with the refined exponential decline curve; and
generate a graphical representation illustrating the refined exponential decline curve and the uncertainty.

12. The computer system of claim 11, wherein the processor is operative to:
determine a noise attributable to the associated exponential decline curve.

13. The computer system of claim 12, wherein the refined mean and the refined covariance are determined utilizing a Bayesian probabilistic updating algorithm which utilizes the mean, the covariance, and the noise.

14. A computer readable medium for forecasting oilfield production comprising instructions which, when executed, cause a computer to:
receive measured oilfield production data;
identify an exponential decline curve associated with the measured oilfield production data;
express the associated exponential decline curve as a two dimensional vector;
determine a mean and a covariance for the two dimensional vector;
determine a refined mean and a refined covariance for the two dimensional vector, wherein the refined mean and the refined covariance are determined utilizing a Bayesian probabilistic updating algorithm; and
generate a refined exponential decline curve utilizing the refined mean and the refined covariance.

15. The computer readable medium of claim 14, wherein the instructions, when executed, cause the computer to:
generate a graphical representation of the refined exponential decline curve.

16. The computer readable medium of claim 14, wherein the instructions, when executed, cause the computer to:
determine a noise attributable to the associated exponential decline curve.

17. The computer readable medium of claim 16, wherein the Bayesian probabilistic updating algorithm utilizes the mean, the covariance, and the noise.

18. The computer readable medium of claim 16, wherein the noise further comprises a difference between the measured oilfield production data and the associated exponential decline curve.

19. The computer readable medium of claim 16, wherein the noise further comprises one or more uncorrelated noise values.

20. The computer readable medium of claim 16, wherein the noise further comprises a weighting indication pertaining to at least a portion of the measured production data.
